(19) United States
(12) Patent Application Publication
(10) Pub. No.: US 2004/0261584 A1
(43) Pub. Date: Dec. 30, 2004

(54) Anti-gridlock wrench

(76) Inventor: Hsiu-Ching Huang, Taipei (TW)

Correspondence Address: BIRCH STEWART KOLASCH & BIRCH, PO BOX 747, FALLS CHURCH, VA, 22040-0747, US

(21) Appl. No.: 10/619,625

(22) Filed: Jul. 16, 2003

(30) Foreign Application Priority Data
Jun. 27, 2003 (TW) 92117719

(51) Int. Cl. B25B 13/46

(52) U.S. Cl. 81/63.1

(57) ABSTRACT

An anti-gridlock wrench includes a handle, a clutch, a detent, a controller, a gear and a C-ring. The handle includes an annular head defining a circular space, a pothole not overlapping the circular space, a channel for communicating the circular space with the pothole, a recess and an annular groove both defined in a wall of the circular space. The clutch includes two claws put in the recess and a spring put between the claws. Each of the claws includes a toothed face, a first rod and a second rod. The claws can easily enter the recess since the first rods can move through the channel. A controller is put rotationally in the pothole for moving the rods. The gear is put in the circular space. The gear includes a toothed face for engagement with the toothed face of one of the claws. The second rods of the claws can impinge each other in order to push one of the claws from the annular gear. The C-ring includes an external edge put in the annular groove, an internal edge for retaining the annular gear in the circular space and a gate projecting from an upper face for blocking the channel.

Anti-Gridlock Wrench

### FIELD OF INVENTION

The present invention relates to an anti-gridlock wrench. Background of Invention Taiwanese Patent Publication No. 380471 discloses a conventional wrench including an annular head 20 and a grip 21 extending from the annular head 20. The annular head 20 defines a space 22, a recess 23 communicated with the space 22, a hole 24 communicated with the recess 23, a hole 25 co-centrically communicated with the hole 24 and a hole 26 eccentrically communicated with the hole 24. The space 22 partially overlaps the hole 24. A clutch is put in the recess 23. The clutch includes two claws 40 and a spring 43 between the claws 40. Each of the claws 40 includes a toothed face 41 and a rod 42. An annular gear 30 is put in the space 22. The annular gear 30 includes a toothed internal face 31 for engagement with a nut or a head of a bolt and a toothed external face 33 for engagement with the toothed face 41 of one of the claws 40. A positioning device 60 is put in the hole 26. The positioning device 60 includes a spring 61 and a ball detent 62. A disc 50 is put in the hole 24. The disc 50 includes a central hole 51 through which a bolt is driven into the hole 25. A recess 52 and two recesses 53 are defined in a lower face of the disc 50. The rods 42 are put in the recess 52. The recess 52 includes two opposite walls in contact with the rods 42. The ball detent 62 can be put in one of the recesses 53. A handle 54 is secured to the disc 50. However, the annular gear 30 is likely to escape the space 22 since it is retained only by means of a portion of the disc 50. Moreover, the claws 40 may stick to the annular gear 30 because of dirt, grease or rust.

The present invention is therefore intended to obviate or at least alleviate the problems encountered in prior art.

### SUMMARY OF INVENTION

The primary objective of the present invention is to provide an anti-gridlock wrench.

According to the present invention, an anti-gridlock wrench includes a handle, a clutch, a detent, a controller, a gear and a C-ring. The handle includes an annular head defining a circular space, a pothole not overlapping the circular space, a channel for communicating the circular space with the pothole, a recess and an annular groove both defined in a wall of the circular space. The clutch includes two claws put in the recess and a spring put between the claws. Each of the claws includes a toothed face, a first rod and a second rod. The claws can easily enter the recess since the first rods can move through the channel. A controller is put rotationally in the pothole for moving the rods. The gear is put in the circular space. The gear includes a toothed face for engagement with the toothed face of one of the claws. The second rods of the claws can impinge each other in order to push one of the claws from the annular gear. The C-ring includes an external edge put in the annular groove, an internal edge for retaining the annular gear in the circular space and a gate projecting from an upper face for blocking the channel.

Other objects, advantages and novel features of the invention will become more apparent from the following detailed description in conjunction with the attached drawings.

### BRIEF DESCRIPTION OF DRAWINGS

The present invention will be described via detailed illustration of the preferred embodiment referring to the drawings.

FIG. 1 is a perspective view of an anti-gridlock wrench according to the preferred embodiment of the present invention.

FIG. 2 is an exploded view of the anti-gridlock wrench of FIG. 1.

FIG. 3-5 are cross-sectional views of the anti-gridlock of FIG. 1.

### DETAILED DESCRIPTION OF PREFERRED EMBODIMENT

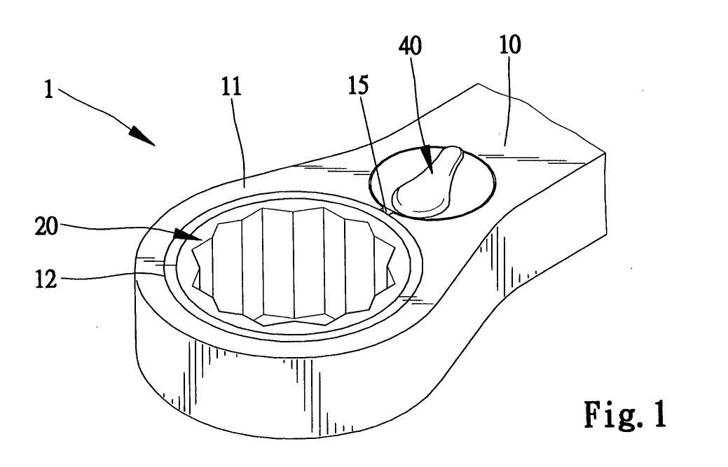

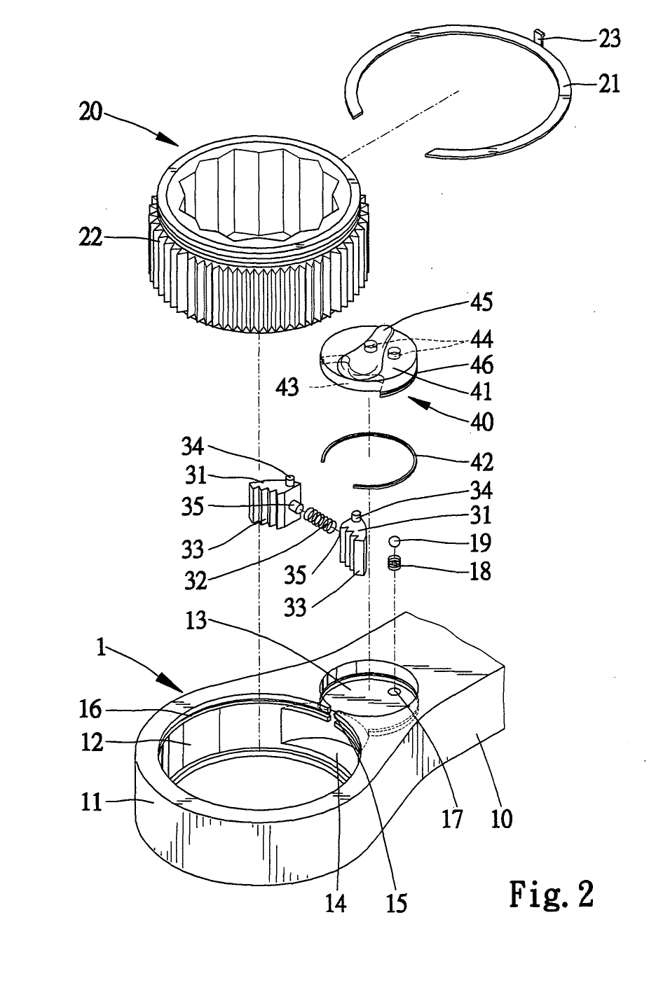

Referring to FIGS. 1-3, according to the preferred embodiment of the present invention, an anti-gridlock wrench 1 includes a handle 10, an annular gear 20, a clutch 30 and a controller 40. The handle 10 includes an annular head 11 and a grip (not numbered) extending from the annular head 11.

The annular head 11 defines a space 12 and a pothole 13. The space 12 is in the form of a large circle. The pothole 13 is in the form of a small circle not overlapping the large circle. The space 12 is communicated with the pothole 13 through a channel 15. An arched recess 14 and an annular groove 16 are defined in the wall of the space 12. The arched recess 14 is communicated with the pothole 13. A hole 17 is defined in the bottom of the pothole 13.

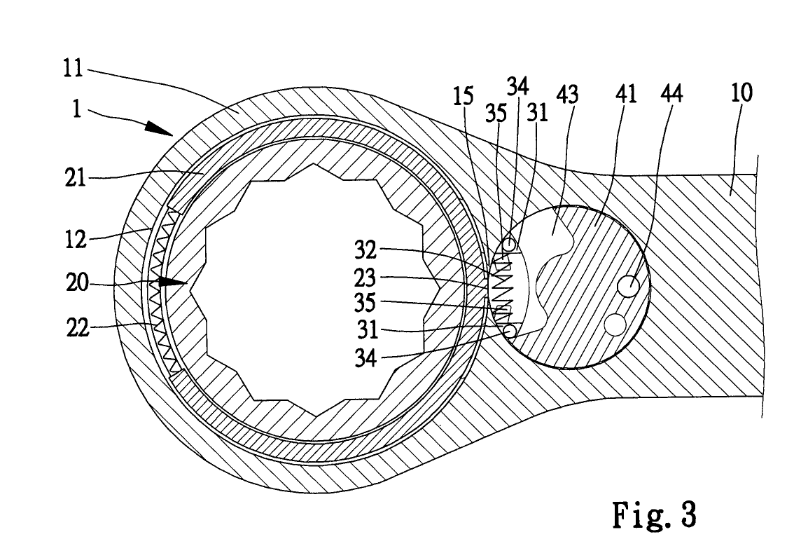

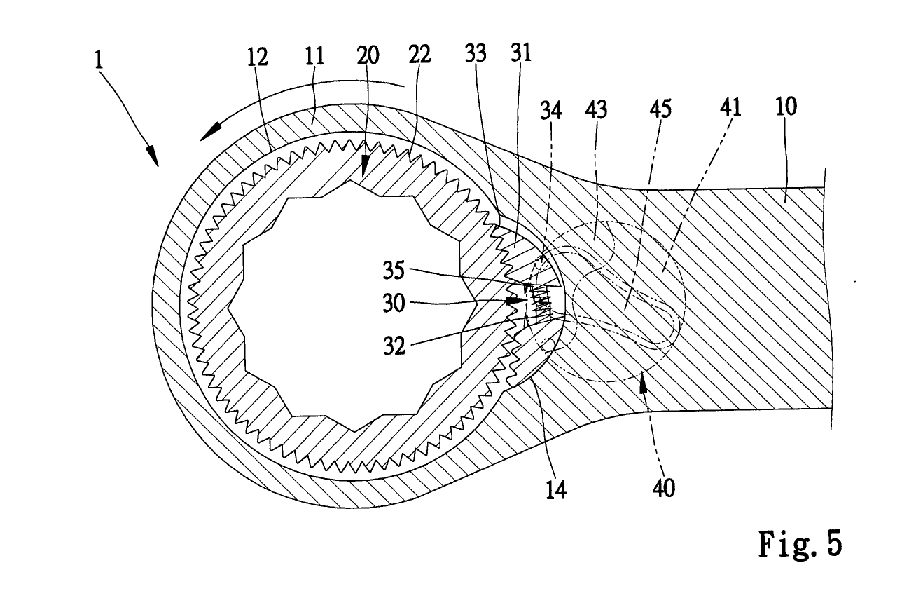

The clutch 30 is put in the arched recess 14. The clutch 30 includes two claws 31 and a spring 32 between the claws 31. For the convenience of description, the claws 31 may be referred to the “upper” and “lower” claws 31 as shown in FIGS. 3-5. Each of the claws 31 includes a toothed face 33, a first rod 34 and a second rod 35. The claws 31 can be put into the arched recess 14 since the rods 34 can be moved through the channel 15. The first rods 34 of the claws 31 extend parallel to each other. The second rods 35 of the claws 31 extend towards each other. The second rod 35 of each of the claws 31 is fit in an end of the spring 32 so that the spring 32 is kept between the claws 31. Another and the most important feature of the second rods 35 of the claws 31 will be described referring to FIG. 5.

A positioning device including a spring 18 and a ball detent 19 is put in the hole 17.

The controller 40 is put in the pothole 13. The controller 40 includes a disc 41 and a C-ring 42. The disc 41 includes an arched recess 43 and two recesses 44 all defined in a lower face. The rods 34 are put in the arched recess 43. The arched recess 43 includes two opposite walls for contact with the rods 42. The ball detent 19 can be put in one of the recesses 44. A ridge 45 is formed on an upper face of the disc 41. The disc 41 defines an annular groove 46 so as to receive an internal edge of the C-ring 42. The wall of the pothole 13 defines an annular groove 47 so as to receive an external edge of the C-ring 42.

The annular gear 20 is put in the space 12. The annular gear 20 includes a toothed internal face (not numbered) for engagement with a nut or a head of a bolt and a toothed external face 22 for engagement with the toothed face 33 of the upper or lower claw 31.

A C-ring 21 includes a gate 23 projecting from an upper face. The C-ring 21 includes an external edge put in the annular groove 16 and an internal edge for retaining the annular gear 20 in the space 12. The channel 15 is shut by means of the gate 23.

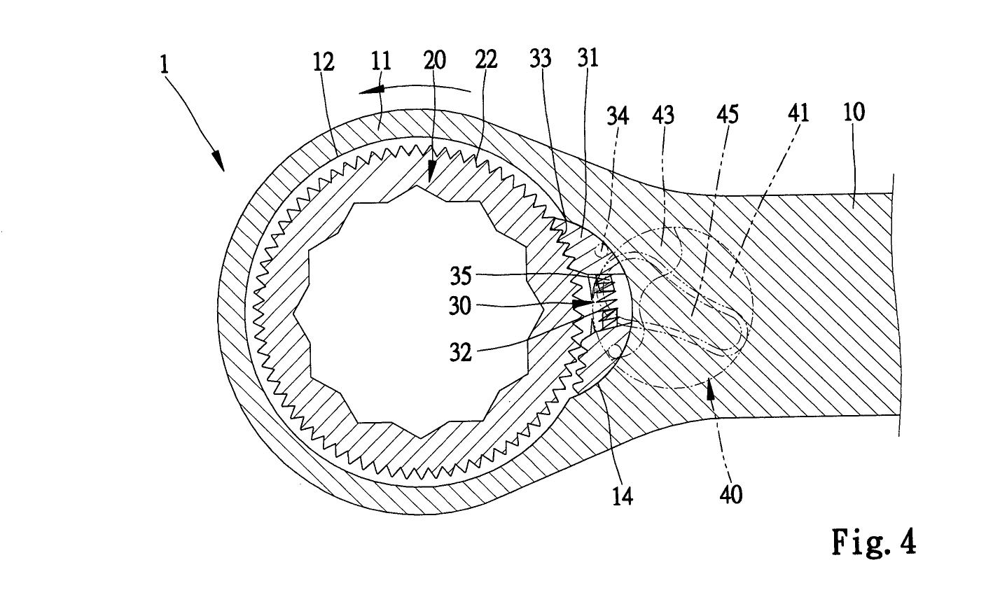

FIG. 4 shows the anti-gridlock wrench 1 in a position where the handle 10 should drive the annular gear 20 only clockwise, i.e., the handle 10 should not drive the annular gear counterclockwise. When the handle 10 is pivoted counterclockwise as indicated by means of an arrowhead in FIG. 4, the wall of the arched recess 43 is moved from the upper claw 31 so as to allow disengagement of the toothed face 33 of the upper claw 31 from the toothed face 22 of the annular gear 20.

However, as shown in FIG. 5, the toothed face 33 of the upper claw 31 may stick to the toothed face 22 of the annular gear 20 due to dirt, grease or rust, and this is not desired. Fortunately, the second rod 35 of the lower claw 31 impinges the second rod 35 of the upper claw 31, thus disengaging the upper claw 31 from the annular gear 20. Thus, the second rods 35 of the claws 31 of the clutch 30 of the present invention advantageously ensure smooth operation of the anti-gridlock wrench 1.

The present invention has been described via detailed illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. An anti-gridlock wrench including:
a handle including an annular head defining a circular space, a pothole not overlapping the circular space, a channel for communicating the circular space with the pothole, an arched recess and an annular groove both defined in a wall of the circular space;
a clutch including two claws put in the arched recess and a spring put between the claws, the claws each including a toothed face, a first rod and a second rod, wherein the claws can easily enter the arched recess since the first rods can move through the channel;
a controller put rotationally in the pothole for moving the rods;
a gear put in the circular space, the gear including a toothed face for engagement with the toothed face of one of the claws, wherein the second rods of the claws can impinge each other in order to push one of the claws from the annular gear; and
a C-ring including an external edge put in the annular groove, an internal edge for retaining the annular gear in the circular space and a gate projecting from an upper face for blocking the channel.

2. The anti-gridlock wrench according to claim 1 wherein the second rod of each of the claws is fit in an end of the spring.

3. The anti-gridlock wrench according to claim 1 wherein the gear is an annular gear including a toothed internal face.

4. The anti-gridlock wrench according to claim 1 including a detent put in a hole defined in a bottom of the pothole, and the controller defines two recesses for receiving the detent.

5. The anti-gridlock wrench according to claim 1 wherein the controller includes a disc put rotationally in the pothole.

6. The anti-gridlock wrench according to claim 5 wherein the disc defines an arched recess for receiving the rods.

7. The anti-gridlock wrench according to claim 5 wherein the controller includes a ridge formed on the disc.

8. The anti-gridlock wrench according to claim 5 wherein the controller includes a C-ring with an internal edge put in an annular groove defined in the disc and an external edge put in an annular groove defined in a wall of the pothole.

9. The anti-gridlock wrench according to claim 5 wherein the controller includes a rod projecting from the disc and through an aperture defined in the annular head, an annular groove defined in the rod, and a C-clip including an internal edge put in the annular groove and an external edge for abutment against the annular head.

10. The anti-gridlock wrench according to claim 5 wherein the controller includes a hole defined in the disc and a bolt driven into the hole through an aperture defined in the annular head.
